(19) United States
(12) Patent Application Publication
(10) Pub. No.: US 2026/0278651 A1
(43) Pub. Date: Sep. 17, 2026

(54) SYSTEM, METHOD, AND COMPUTER PROGRAM FOR ADAPTIVE DOCUMENT AGGREGATION AND MANAGEMENT USING ARTIFICIAL INTELLIGENCE

(71) Applicant: BILL Operations, LLC, San Jose, CA (US)

(72) Inventors: Eric Chan, Hayward, CA (US); Henrique Ceribelli, San Jose, CA (US); Mohsen Sardari, Burlingame, CA (US); Julien Denaes, Louisville, CO (US); Max Stepin, Redmond, WA (US); Ken Moss, Menlo Park, CA (US); Jeremy Neuberger, Clayton, NC (US)

(21) Appl. No.: 19/082,020

(22) Filed: Mar. 17, 2025

(51) Int. Cl. G06Q 30/04; G06F 21/60

(52) U.S. Cl. CPC G06Q 30/04; G06F 21/602

(57) ABSTRACT

Intelligence invoice aggregation and management system and methods are provided. In use, the techniques described herein relate to retrieving billing data from multiple sources including direct biller relationships, emails, email attachments, open APIs, secured APIs, open websites or portals, and password-protected websites or portals. User credentials for accessing password-protected sources are securely stored and managed. Artificial intelligence (AI) is utilized to adaptively navigate and extract bills from at least one of open websites, open portals, or password-protected portals, or configure email forwarding to receive bills in a designated customer billing inbox. Automated synchronization for recurring data retrieval tasks is performed. Billing data from various sources is normalized into a unified format. The consolidated billing data is presented to a user through a user interface. As such, the intelligent invoice system leverages AI-driven navigation to adapt to changing website layouts and API structures, streamlining bill retrieval and consolidation for improved efficiency and user experience.

### FIELD OF THE INVENTION

The present disclosure relates to document management systems, and more particularly to an intelligent financial document presentment and ingestion system using artificial intelligence and secure credential management.

### BACKGROUND

The field of document management, and invoice management in particular, faces significant challenges in efficiently aggregating and processing billing information from multiple sources. This issue has become increasingly important due to the proliferation of digital billing systems, each with its own unique interface and data format. Businesses and individuals alike struggle to maintain a comprehensive view of their financial obligations across various vendors, utilities, and service providers.

Existing systems attempting to address this problem encounter several obstacles. These include the diversity of billing platforms, ranging from direct API integrations to password-protected web portals, which limit their effectiveness in providing a unified billing experience. Additionally, the dynamic nature of web interfaces and API structures poses a constant challenge to maintaining reliable connections with billing sources. Furthermore, the sensitive nature of financial data necessitates robust security measures, adding another layer of complexity to the aggregation process.

For instance, in scenarios where businesses deal with multiple vendors, current solutions often fail to adapt to changes in vendor portals without manual intervention, leading to missed or delayed invoice processing. Another example is the handling of multi-factor authentication, where existing methods are unable to seamlessly manage the authentication process across various platforms, resulting in frequent disruptions to automated data retrieval. These shortcomings highlight the need for a more intelligent and adaptable approach to invoice aggregation and management.

As such, there is thus a need for addressing these and/or other issues associated with the prior art.

### SUMMARY

Intelligence invoice aggregation and management system and methods are provided. In use, the techniques described herein relate to retrieving billing data from multiple sources including direct biller relationships, emails, email attachments, open APIs, secured APIs, open websites or portals, and password-protected websites or portals. User credentials for accessing password-protected sources are securely stored and managed. Artificial intelligence (AI) is utilized to adaptively navigate and extract bills from at least one of open websites, open portals, or password-protected portals, or configure email forwarding to receive bills in a designated customer billing inbox. Automated synchronization for recurring data retrieval tasks is performed. Billing data from various sources is normalized into a unified format. The consolidated billing data is presented to a user through a user interface. As such, the intelligent invoice system leverages AI-driven navigation to adapt to changing website layouts and API structures. It manages secure credentials, handles multi-factor authentication, and normalizes data from diverse sources, streamlining bill retrieval and consolidation for improved efficiency and user experience.

In some aspects, the techniques described herein relate to a system, wherein the AI utilizes a multi-modal large language model to process visual inputs, text, and computer-readable markup for navigating password-protected portals.

In some aspects, the techniques described herein relate to a system, wherein the AI employs computer vision and natural language processing techniques to interpret website screen layouts in real-time.

In some aspects, the techniques described herein relate to a system, wherein the system further includes a user communication hub for managing interactions on behalf of the user, including handling verifications and messages needed for multi-factor authentication.

In some aspects, the techniques described herein relate to a system, wherein the user communication hub interfaces with the AI to automatically process authentication requests and provide necessary responses.

In some aspects, the techniques described herein relate to a system, wherein: the secure storage of user credentials utilizes advanced encryption techniques; and the system employs multi-factor authentication for accessing the stored credentials.

In some aspects, the techniques described herein relate to a system, wherein the automated synchronization includes: scheduling and executing periodic data retrieval tasks based on predefined intervals; and implementing error handling and retry mechanisms to address temporary connectivity issues.

In some aspects, the techniques described herein relate to a system, wherein the normalization of billing data includes: standardizing date formats, currency representations, and invoice structures across different billing sources; and appending additional contextual information or metadata to the billing data.

In some aspects, the techniques described herein relate to a system, wherein presenting the consolidated billing data includes: generating interactive visualizations and summary reports; and providing customizable views and filtering options to cater to different user preferences.

In some aspects, the techniques described herein relate to a system, wherein the system further incorporates AI-powered insights and recommendations based on the consolidated billing data.

In some aspects, the techniques described herein relate to a system, wherein the system further includes a machine learning-based anomaly detection module that identifies unusual patterns in billing data.

In some aspects, the techniques described herein relate to a system, wherein the anomaly detection module alerts users to potential errors or fraudulent charges.

In some aspects, the techniques described herein relate to a system, wherein the AI navigation module is further enhanced with natural language generation capabilities to interact with customer service chatbots on biller websites.

In some aspects, the techniques described herein relate to a system, wherein the system integrates with external financial planning tools, allowing users to incorporate their consolidated billing data into broader financial analyses and forecasts.

In some aspects, the techniques described herein relate to a system, wherein: the system utilizes crowdsourced website navigation patterns for navigating biller websites; and the crowdsourced patterns are aggregated from anonymized user experiences.

In some aspects, the techniques described herein relate to a system, wherein the system incorporates blockchain technology for invoice verification and storage, providing a tamper-proof audit trail for all processed invoices.

In some aspects, the techniques described herein relate to a system, wherein the system implements tokenization and OAuth 2.0 protocols for credential-less bill retrieval, eliminating the need for storing sensitive user credentials.

In some aspects, the techniques described herein relate to a system, wherein the system employs a hybrid cloud-edge computing architecture, performing sensitive operations on edge devices and conducting data aggregation and analysis tasks in the cloud.

### BRIEF DESCRIPTION OF THE DRAWINGS

FIG. 1 illustrates a flowchart of a method for intelligent invoice presentment and ingestion, according to aspects of the present disclosure.

FIG. 2 illustrates a block diagram of an intelligent invoice presentment and ingestion system, according to an embodiment.

FIG. 3 illustrates a block diagram of an invoice processing system, in accordance with example embodiments.

FIG. 4 illustrates a block diagram of a document processing system, according to aspects of the present disclosure.

FIG. 5 depicts a network system for facilitating communication between multiple devices, according to an embodiment.

FIG. 6 shows a block diagram of a computing system, in accordance with example embodiments.

### DETAILED DESCRIPTION

The present disclosure relates to the field of invoice management and financial data aggregation, specifically focusing on intelligent systems for retrieving, consolidating, and managing billing information from multiple sources. This technology addresses the growing complexity of digital billing systems and the need for comprehensive financial oversight in both business and personal contexts.

Current invoice management solutions face significant challenges in efficiently aggregating and processing billing information from diverse sources. These challenges include the inability to adapt to changes in vendor portals without manual intervention, difficulties in handling multi-factor authentication across various platforms, and the struggle to maintain a unified view of financial obligations across multiple vendors, utilities, and service providers. Additionally, existing systems often fail to provide robust security measures necessary for handling sensitive financial data.

The present disclosure introduces an intelligent invoice presentment and ingestion system that leverages artificial intelligence and secure credential management to overcome these challenges. The system employs an AI-driven navigation module capable of adapting to changes in website layouts and API structures in real-time, ensuring consistent and reliable data retrieval without manual reconfiguration. It also incorporates a secure credential management module that utilizes advanced encryption techniques for storing and managing user credentials, addressing the security concerns associated with accessing multiple password-protected sources.

Furthermore, the disclosure herein features a comprehensive data aggregation module that retrieves billing data from various sources, including direct biller relationships, emails, email attachments, open APIs, secured APIs, open websites or portals, and password-protected websites or portals. The system's automated synchronization module performs recurring data retrieval tasks, while a data normalization module consolidates billing information from heterogeneous sources into a unified format. These features, combined with a user-friendly interface for presenting consolidated billing data, provide a holistic solution that significantly improves the efficiency and accuracy of invoice management processes.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Exemplary Embodiments

The following description sets forth exemplary aspects of the present disclosure. It should be recognized, however, that such description is not intended as a limitation on the scope of the present disclosure. Rather, the description also encompasses combinations and modifications to those exemplary aspects described herein.

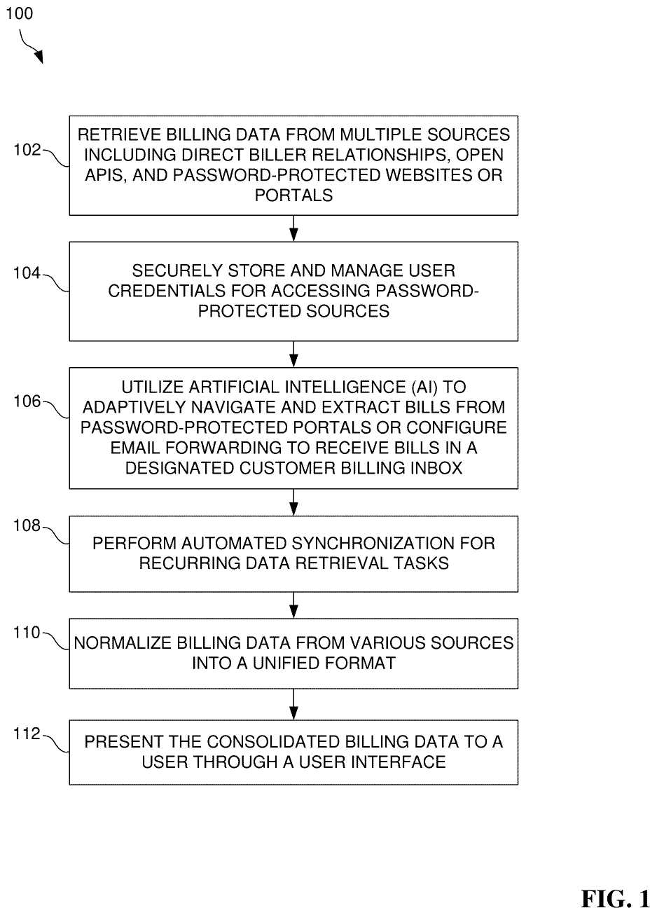

FIG. 1 illustrates a flowchart of a method 100 for intelligent invoice presentment and ingestion, in accordance with one embodiment. As an option, the method 100 may be implemented in the context of any one or more of the embodiments set forth in any previous and/or subsequent Figures and/or description thereof. Of course, however, the method 100 may be implemented in the context of any desired environment. Further, the aforementioned definitions may equally apply to the description below.

At step 102, billing data is retrieved from multiple sources including direct biller relationships, open APIs, and password-protected websites or portals. For example, the retrieval of billing data from multiple sources may involve establishing secure connections with various billing platforms and systems. This process may include interfacing with direct biller relationships through dedicated APIs or secure file transfer protocols, ensuring a seamless and efficient data exchange. For open APIs, the system may implement OAuth 2.0 or similar authentication mechanisms to securely access and retrieve billing information. In the case of password-protected websites or portals, the system may employ advanced web scraping techniques or utilize specialized browser automation tools to navigate and extract relevant billing data.

The data retrieval process may also involve handling different data formats and structures from various sources. The system may implement adaptive parsing algorithms capable of interpreting and extracting relevant information from diverse document types, such as PDFs, HTML pages, and/or structured data feeds. In some cases, the system may employ machine learning techniques to improve the accuracy and efficiency of data extraction over time, learning from patterns and user feedback to refine its parsing capabilities. In various embodiments, this standardization process may involve mapping different data formats to a common schema, ensuring consistency across all retrieved billing information.

Additionally, in various embodiments, all data retrieval processes may be queued. These queued processes may have automatic retries with a limit on retries. When the retry limit is hit, the process will be segmented and alerted upon for attention. Such a structure will address potential types of errors, including recoverable and unrecoverable. Recoverable errors, such as a source system not responding, may be automatically resolved through intelligent retries. Unrecoverable errors, such as a corrupted document, may need alerting and adjustment based on the specific situation. Once addressed, this process will be requeued for processing. As such, a categorization step may be applied to separate the types of failures (e.g. system is not responsive, the document is corrupted, the pdf is not loading, etc.), where based on the category of fail a proper mechanism to address may be applied.

At step 104, user credentials for accessing password-protected sources are securely stored and managed. For example, the system may utilize advanced encryption algorithms, such as AES-256, to protect sensitive login information at rest and in transit. Credentials may be stored in a secure, isolated database with restricted access controls and security audits to prevent unauthorized access. In some implementations, the system may leverage hardware security modules (HSMs) for additional protection of encryption keys and sensitive operations.

The credential management process may also include features for automatic credential rotation and updates. This may involve implementing protocols for periodic password changes, managing API keys with expiration dates, and/or handling multi-factor authentication requirements. The system may provide users with options to securely update their credentials through encrypted channels and may implement fail-safe mechanisms to prevent accidental lockouts or data loss during credential updates.

In various embodiments, the system may employ multi-factor authentication and regular security audits to maintain the integrity of the stored credentials.

At step 106, artificial intelligence (AI) is utilized to adaptively navigate and extract bills from password-protected portals or configure email forwarding to receive bills in a designated customer billing inbox. For example, the use of AI may involve implementing sophisticated machine learning algorithms and computer vision techniques. The AI system may employ natural language processing (NLP) to interpret and interact with various portal interfaces, enabling it to understand and navigate complex web structures. In some cases, the AI may use reinforcement learning techniques to optimize its navigation strategies over time, adapting to changes in website layouts and improving its efficiency in locating and extracting relevant billing information.

For email forwarding configuration, the AI system may analyze email patterns and content to identify billing-related messages accurately. It may implement filtering algorithms to distinguish between various types of financial communications and automatically configure forwarding rules to ensure bills are correctly routed to the designated customer billing inbox. The AI may also learn from user behavior and preferences to fine-tune its forwarding decisions, potentially offering suggestions for improved inbox organization based on observed patterns.

Additionally, the AI-driven navigation may employ machine learning algorithms to analyze and adapt to changes in website layouts and portal structures. This adaptive capability ensures consistent bill extraction even when billing portals undergo updates or modifications.

At step 108, automated synchronization is performed for recurring data retrieval tasks. For example, a robust scheduling and execution system may be implemented. This may include developing a flexible job scheduler capable of handling various synchronization frequencies, from real-time updates to daily, weekly, and/or monthly cycles, depending on the nature of the billing source and user preferences. The system may employ intelligent load balancing techniques to distribute synchronization tasks across available resources, ensuring optimal performance and minimizing the impact on source systems during peak times.

The automated synchronization process may also incorporate error handling and retry mechanisms. This could involve implementing exponential backoff algorithms for failed retrieval attempts, intelligent error classification to distinguish between temporary network issues and more persistent problems, and/or automated alerting systems to notify administrators of recurring synchronization failures. In some cases, the system may employ predictive analytics to anticipate potential synchronization issues based on historical patterns and proactively adjust its retrieval strategies.

Additionally, the automated synchronization process may include scheduling and executing periodic data retrieval tasks based on predefined intervals or specific trigger events. This ensures that the system maintains up-to-date billing information without manual intervention.

At step 110, billing data from various sources is normalized into a unified format. For example, this step may involve multiple stages of data transformation and enrichment. The system may implement a flexible schema mapping engine capable of translating diverse input formats into a standardized data model. This could include handling different date formats, currency representations, and/or invoice structures across various billing sources. In some cases, the normalization process may employ machine learning techniques to improve its mapping accuracy over time, learning from manual corrections and adapting to new data formats as they are encountered. With respect to multi-currency invoices and/or currency conversions, the system may follow preferences as defined in a general ledger, as well as customer input (such as what they have set up within the database). In one embodiment, currencies may be recorded as they are (without any conversion). Additionally, the dates may be normalized to the format that the system understands and may sync accordingly to the ledger.

The normalization step may also include data enrichment processes, where additional contextual information or metadata may be appended to the billing data. This could involve integrating with external data sources to add industry classifications, geographic information, and/or other relevant attributes to enhance the usefulness of the consolidated billing data. The system may also implement data quality checks and/or validation rules to ensure the integrity and consistency of the normalized data, flagging potential issues for review and correction. With respect to validating and verifying the accuracy of extracted invoice data, a variety of verifications may be applied. For example, a first level of verification may be applied at the file level (e.g. does the pdf open, is the jpeg coded correctly, etc.). A second level of verification may look at previous instances of the invoices from the same vendor that are in the system and compare the text and layout with the vast corpus of the invoices found in our system. If the layout and text deviate from the past, such may be used to notify the user for manual verification

At step 112, the consolidated billing data is presented to a user through a user interface. For example, this step may include designing and implementing a comprehensive visualization and interaction system. This may include developing interactive dashboards that provide users with high-level overviews of their billing data, as well as detailed drill-down capabilities for in-depth analysis. The user interface may incorporate advanced data visualization techniques, such as heat maps, treemaps, and/or network graphs, to help users identify patterns and trends in their billing data across multiple dimensions.

In various embodiments, specific data enrichment process may be applied to enhance the usefulness of consolidated billing information. For example, the data from a single invoice may be enriched with the history of past invoices and payment information attached for the same organization and vendor pair. In some instances, the system may enrich the invoice with data from similar types of goods and services that are benchmarked in the system.

The presentation layer may also include customizable reporting features, allowing users to generate tailored reports based on specific criteria or time periods. This could involve implementing a flexible report builder with drag-and-drop functionality, enabling users to create and save custom report templates. In some cases, the system may employ AI-driven insights to proactively highlight notable trends, anomalies, or cost-saving opportunities within the consolidated billing data, providing users with actionable intelligence to optimize their financial management strategies.

Based on the consolidated billing data, AI-driven insights may be generated. For example, data from a single invoice may be enriched with history of the past invoices and the payment information attached for the same organization and vendor pair. In some instances, the invoice may be enriched with data from similar types of goods and services benchmarked in the system. In particular, the AI system may deduce the semantic similarity of the different services and goods in the context of the vendor even if they are called slightly differently (for example, the AI system may deduce similarities and differences between a 15-inch Macbook, and a 15-inch apple laptop).

As such, the presentation of consolidated billing data may involve generating interactive visualizations, summary reports, and/or detailed breakdowns of financial information. The user interface may offer customizable views and filtering options to cater to different user preferences and analysis needs. The system may also incorporate AI-powered insights and recommendations based on the consolidated billing data, providing users with actionable financial intelligence and potential cost-saving opportunities.

In various embodiments, AI-powered bill categorization may be used to automatically classify invoices by type and urgency. This feature may enhance the organization and prioritization of billing information, enabling users to focus on critical financial obligations more effectively. In some cases, multi-language processing of invoices may be provided. This capability may involve automated translation services and localization features to ensure accurate interpretation of billing information across different languages and regions.

Additionally, machine learning-based fraud detection may be incorporated to identify suspicious patterns in billing data. This advanced security feature may analyze historical billing patterns, transaction anomalies, and/or other relevant factors to flag potential fraudulent activities or discrepancies in the billing information.

In some embodiments, the AI navigation module may utilize a multi-modal large language model to process visual inputs, text, and computer-readable markup for navigating password-protected portals. This AI system may adaptively learn and update navigation patterns for each unique portal interface, employing computer vision techniques to recognize and interact with dynamic web elements, including CAPTCHAs and multi-factor authentication prompts. The module may utilize natural language processing to interpret and respond to context-sensitive instructions or error messages encountered during navigation. To maintain consistent performance, the AI navigation module may implement a self-healing mechanism that automatically adjusts navigation strategies in response to changes in portal layouts or functionality without manual intervention. Furthermore, the system may generate and maintain a knowledge graph of portal structures and navigation paths, enabling efficient transfer learning between similar portal interfaces.

The secure credential management module may employ a hardware security module (HSM) for encryption key management and sensitive cryptographic operations. In some implementations, it may utilize a zero-knowledge proof system for credential verification, allowing the system to authenticate users without storing or transmitting actual credentials. The module may also leverage homomorphic encryption techniques to perform operations on encrypted credentials without decrypting them, enhancing security during credential use. To further isolate sensitive operations, the system may provide a secure enclave for temporary credential decryption and use during automated login processes. Additionally, the credential management module may implement an AI-driven anomaly detection system to identify and flag suspicious credential usage patterns or potential security breaches in real-time.

In one embodiment, the credential management module may manage password rotation policies and/or expired credentials. For example, users can provide a master password to the credential management module, and such module may manage the rotation of the password on their behalf, may store such passwords in a secure format (which the user can view with their master password). Additionally, the user may be informed when a rotation is done on their behalf. If the user opts out, the user may update the password directly and provide the updated password to the system (i.e. the credential management module).

In various aspects, the data normalization module may employ a self-learning schema mapping engine that utilizes machine learning to continuously improve data transformation rules based on encountered variations in billing data formats. This module may implement a probabilistic entity resolution system to accurately match and merge billing information from multiple sources relating to the same entity or transaction. To handle diverse input formats, the normalization module may utilize natural language processing techniques to extract and standardize unstructured billing information from various document formats, including PDFs and scanned images. The system may apply contextual analysis to infer and standardize missing or ambiguous data fields based on historical patterns and industry-specific knowledge bases. To ensure data integrity and traceability, the module may maintain a versioned history of normalization rules and transformations, enabling auditable data lineage and the ability to reprocess historical data with improved algorithms.

The automated synchronization module may implement an adaptive scheduling algorithm that optimizes retrieval frequencies based on historical data patterns, known billing cycles, and/or real-time system load. To enhance performance and scalability, it may utilize a distributed task execution framework to parallelize and load-balance synchronization jobs across a scalable cluster of worker nodes. The module may employ predictive analytics to anticipate and proactively address potential synchronization failures or performance bottlenecks. To ensure data consistency, the system may implement a transactional synchronization protocol that maintains integrity across multiple sources in the event of partial failures or interruptions. Furthermore, the synchronization module may provide a real-time monitoring and alerting system that uses machine learning to distinguish between normal variations and anomalous behaviors in the synchronization process.

In various embodiments, the systems may be configured to record signals associated with when invoices for a vendor became available in the past and due date patterns observed with the past invoices. The automated synchronization module may receive the payment due dates and payment terms as a signal to prioritize the retrieval and processing order of invoices. Additionally, the system will not only use billing info data extracted from the invoice or other financial document, but it will also use data from when past documents were manually uploaded/received in the system in a global view of that vendor, in view of the network capabilities and high volume of data inputted by users. It is to be understood that within the context of the present disclosure, the use of the term “document” may refer to a financial document and/or invoice, but may be expanded to include any document. For example, document may include, but not be limited solely to, utility bills, credit card statements, loan repayment schedules, bank statements, invoices for streaming services, mobile and internet bills, medical bills, insurance premium notices, membership fees for gyms or professional organizations, invoices from online shopping platforms, property tax notices, and tuition fee statements.

In some implementations, the user interface module may incorporate an AI-driven insights engine that analyzes consolidated billing data to provide personalized, actionable recommendations for cost optimization and financial planning. To enhance user experience, the module may utilize augmented reality techniques to overlay billing data and analytics onto physical documents or real-world objects when accessed through mobile devices. The system may provide a natural language interface allowing users to query and analyze their billing data using conversational language, with the AI interpreting intent and generating appropriate visualizations or reports. To facilitate teamwork, the user interface module may implement a collaborative workspace feature enabling multiple users to simultaneously view, annotate, and analyze billing data in real-time, with role-based access controls and audit logging. Additionally, the module may offer predictive modeling capabilities that allow users to create and visualize “what-if” scenarios based on potential changes in billing patterns or business operations, providing valuable insights for strategic decision-making.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

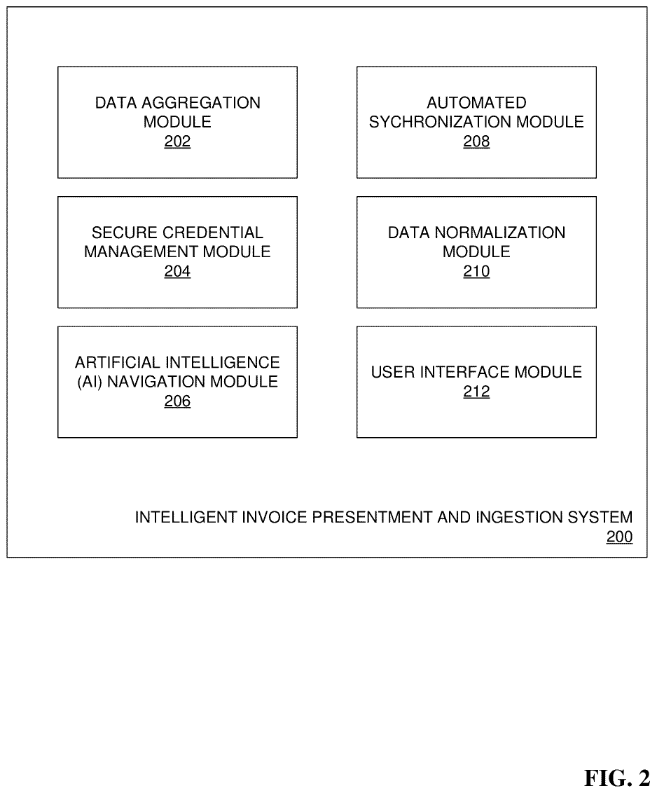

FIG. 2 illustrates a block diagram of an intelligent invoice presentment and ingestion system 200, in accordance with one embodiment. As an option, the intelligent invoice presentment and ingestion system 200 may be implemented in the context of any one or more of the embodiments set forth in any previous and/or subsequent Figures and/or description thereof. Of course, however, the intelligent invoice presentment and ingestion system 200 may be implemented in the context of any desired environment. Further, the aforementioned definitions may equally apply to the description below.

The intelligent invoice presentment and ingestion system 200 includes multiple modules that work together to process and manage invoice data. A data aggregation module 202 may retrieve billing data from multiple sources including direct biller relationships, open APIs, and password-protected websites or portals. The data aggregation module 202 may interface with various external systems to collect invoice information from diverse sources, ensuring comprehensive coverage of a user's financial obligations.

In some cases, the data aggregation module 202 may employ different strategies for retrieving data based on the source type. For direct biller relationships, the module may use established protocols to fetch data directly from partner systems. When dealing with open APIs, the data aggregation module 202 may utilize standardized methods to request and receive billing information.

A secure credential management module 204 may store and manage user credentials for accessing password-protected sources. The credential module 204 may employ encryption techniques to safeguard sensitive login information, ensuring that user data remains protected from unauthorized access. In some cases, the credential module 204 may also handle token-based authentication methods for APIs that require secure access keys.

To enhance security further, the credential module 204 may employ techniques like salting and key stretching to defend against brute-force attacks and rainbow table vulnerabilities. In addition to secure storage, the credential module 204 may provide functionality for credential rotation and updates. It may also integrate with the system's user management and access control mechanisms to ensure that only authorized personnel can access or modify credential information.

An artificial intelligence (AI) navigation module 206 may adaptively navigate and extract bills from password-protected portals. The AI navigation module 206 may use a multi-modal large language model that processes visual inputs, text, and/or computer-readable markup to handle dynamic and complex website navigation. This approach allows the system to adapt to changes in website layouts or structures without requiring manual reconfiguration. This module may utilize a combination of natural language processing (NLP), computer vision, and/or machine learning algorithms to interpret and interact with diverse web interfaces. The AI navigation module may implement reinforcement learning techniques to optimize its navigation strategies over time, adapting to changes in website layouts and improving its efficiency in locating and extracting relevant billing information.

In various embodiments, the AI navigation module 206 may be used to handle dynamic content. For example, The AI navigation module 206 may leverage a Computer-Using Agent (CUA) model which may effectively interpret screenshots of webpages and interact as a user would (such as clicking and typing). As such, the underlying technologies employed on the site are unlikely to impact the effectiveness of the module. Further, the system navigates password-protected portals by leveraging AI models that simulate human interaction (for example, through keyboard and mouse inputs). When dealing with AJAX-based websites, the AI navigation module 206 may actively track page events, detecting when content is dynamically injected instead of being immediately available in the HTML source. To handle this, the AI navigation module 206 may continuously monitor the DOM, recognizing when key elements are updated. If necessary, the system may mimic natural user behavior (such as scrolling, clicking, and form interactions) to trigger content loading. In this manner, the system may ensure that the AI can successfully retrieve bills even from complex, dynamically generated webpages.

To enhance its capabilities, the AI navigation module 206 may incorporate transfer learning approaches, allowing it to apply knowledge gained from navigating one portal to similar portals, reducing the learning curve for new billing sources. The module may also employ anomaly detection algorithms to identify unusual changes in portal structures or behaviors, triggering alerts for human review when necessary. Additionally, the AI navigation module may implement self-healing mechanisms, automatically adjusting its navigation strategies in response to errors or changes in portal interfaces to maintain consistent performance.

In some cases, the AI navigation module 206 may employ computer vision and natural language processing techniques to interpret website screen layouts in real-time. This capability enables the module to identify and interact with relevant elements on a webpage, such as login forms, navigation menus, and/or invoice download buttons, even if their positions or appearances change over time.

An automated synchronization module 208 may perform recurring data retrieval tasks. The synchronization module 208 may schedule and execute regular checks for new invoices or updates to existing billing information across all connected sources. In some cases, the synchronization module 208 may adjust its retrieval frequency based on known billing cycles or user preferences to optimize system performance and ensure timely data updates.

The synchronization module 208 may be responsible for performing automated and recurring data retrieval tasks across all connected billing sources. The synchronization module may employ intelligent load balancing techniques to distribute tasks across available system resources, ensuring optimal performance and minimizing the impact on source systems during peak times. To enhance reliability, the synchronization module 208 may incorporate advanced error handling and retry mechanisms.

A data normalization module 210 may consolidate billing data from various sources into a unified format. The normalization module 210 may process incoming data from different vendors and standardize it into a consistent structure, making it easier for users to compare and analyze their financial information across multiple providers. In some cases, the normalization module 210 may also perform currency conversions or apply specific categorization rules to enhance the usefulness of the consolidated data.

The normalization module 210 may be tasked with consolidating billing data from various sources into a unified and standardized format. This module may implement a flexible schema mapping engine capable of translating diverse input formats into a consistent data model. The normalization process may involve handling different date formats, currency representations, and/or invoice structures across various billing sources. To improve accuracy and adaptability, the module may employ machine learning techniques to refine its mapping rules over time, learning from manual corrections and adapting to new data formats as they are encountered.

In addition to data standardization, the normalization module 210 may perform data enrichment processes to enhance the value of the consolidated billing information. This could involve integrating with external data sources to append industry classifications, geographic information, or other relevant attributes to the billing data. The module may also implement comprehensive data quality checks and validation rules to ensure the integrity and consistency of the normalized data. These checks may include automated detection of outliers, duplicate entries, or inconsistencies across related data points, flagging potential issues for review and correction.

A user interface module 212 may present the consolidated billing data to users. The user interface module 212 may provide intuitive visualizations, search capabilities, and/or filtering options to help users navigate and understand their aggregated billing information. In some cases, the user interface module 212 may also offer customization features, allowing users to tailor the presentation of their financial data according to their preferences.

The user interface module 212 may be responsible for presenting the consolidated billing data to users in an intuitive and actionable format. This module may implement a responsive and customizable dashboard interface, providing users with high-level overviews of their billing data as well as detailed drill-down capabilities for in-depth analysis. The user interface may incorporate advanced data visualization techniques, such as interactive charts, heat maps, and/or network graphs, to help users identify patterns and trends in their billing data across multiple dimensions.

To enhance user experience and productivity, the user interface module 212 may offer customizable reporting features, allowing users to generate tailored reports based on specific criteria or time periods. This could involve implementing a flexible report builder with drag-and-drop functionality, enabling users to create and save custom report templates. The module may also leverage AI-driven insights to proactively highlight notable trends, anomalies, or cost-saving opportunities within the consolidated billing data.

In various embodiments, the intelligent invoice presentment and ingestion system 200 may also incorporate a user communication hub for managing interactions on behalf of the customer. This communication hub may handle verifications and messages needed for multi-factor authentication when accessing password-protected portals. In some cases, the communication hub may interface with the AI navigation module 206 to automatically process authentication requests and provide necessary responses, streamlining the data retrieval process for users.

The modules within the intelligent invoice presentment and ingestion system 200 may work in concert to provide a seamless experience for users. For example, when a new invoice source is added, the data aggregation module 202 may initiate the process, the credential module 204 may securely store necessary login information, and the AI navigation module 206 may learn how to navigate the new portal. The synchronization module 208 may then incorporate the new source into its regular retrieval schedule, while the normalization module 210 ensures that data from the new source is properly integrated into the unified format.

In various embodiments, the intelligent invoice presentment and ingestion system 200 may be extended to include additional features for enhanced financial management. For instance, the system may incorporate a machine learning-based anomaly detection module that identifies unusual patterns in billing data, alerting users to potential errors or fraudulent charges.

In various embodiments, the AI navigation module 206 may be further enhanced with natural language generation capabilities, allowing it to interact with customer service chatbots on biller websites when human-like communication is required to resolve access issues or retrieve specific information.

In various embodiments, the intelligent invoice presentment and ingestion system 200 may integrate with external financial planning tools, allowing users to incorporate their consolidated billing data into broader financial analyses and forecasts. This integration may enable more comprehensive financial management by providing a holistic view of both income and expenses across multiple accounts and providers.

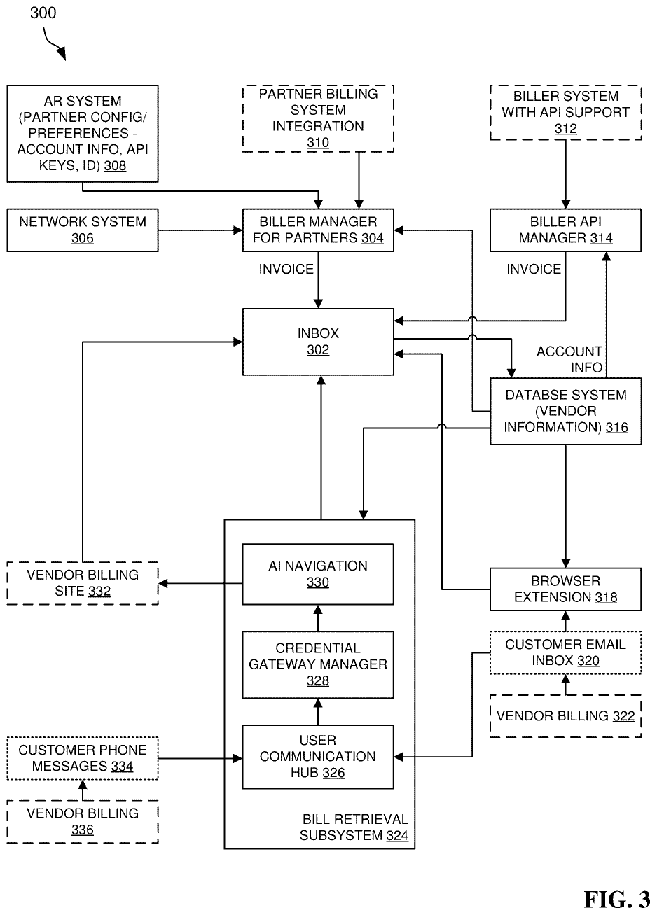

FIG. 3 illustrates a block diagram of an invoice processing system 300, in accordance with one embodiment. As an option, the invoice processing system 300 may be implemented in the context of any one or more of the embodiments set forth in any previous and/or subsequent Figures and/or description thereof. Of course, however, the invoice processing system 300 may be implemented in the context of any desired environment. Further, the aforementioned definitions may equally apply to the description below.

The invoice processing system 300 includes a message inbox 302 that receives invoices from multiple sources. A partner biller manager 304 interfaces with a network interface 306 and an account system 308. The account system 308 may contain partner configuration information, preferences, account information, and API keys. A partner integration module 310 connects to the partner biller manager 304.

In some cases, the message inbox 302 may serve as a centralized repository for all incoming invoices, regardless of their source or format. The partner biller manager 304 may facilitate direct connections with partner billing systems, streamlining the invoice retrieval process for established relationships.

A biller interface 312 connects to the biller api manager 314, which interfaces with a vendor database 316 (receipt of account info) and the inbox 3402 (delivery of invoice). The vendor database 316 stores vendor information and connects to a browser module 318. The browser module 318 interfaces with a customer email inbox 320 that receives communications from a vendor portal 322.

The biller api manager 314 may handle API-based interactions with various billing systems, ensuring compatibility and efficient data exchange. The browser module 318 may simulate user interactions with web-based vendor portals, enabling automated invoice retrieval from sources that do not offer direct API access.

A retrieval subsystem 324 includes multiple components for bill retrieval and processing. Within this subsystem, a communication module 326 manages interactions between various components. The communication module 326 receives inputs from customer email inbox 320 and customer message system 334, which in turn connects to a credential manager 328, which connects to an AI navigation engine 330, which interfaces with a vendor billing portal 332. The vendor billing portal 332 and the retrieval subsystem 324 may each likewise connect to the inbox 302. In one embodiment, the AI navigation engine 330 may leverage a computer-using agent (CUA) model. Further, to mimic the human behavior the models behind the CUA, a vision transformer may be used to understand the visual inputs coming from the rendered page and use a planner and action model to guide keyboard (and mouse) input to enable navigation.

The retrieval subsystem 324 may orchestrate the entire invoice retrieval process, coordinating the efforts of various specialized modules. The AI navigation engine 330 may employ machine learning algorithms to adapt to changes in vendor portal layouts and structures, ensuring consistent invoice extraction.

The system includes interfaces to external systems including a customer message system 334 and a vendor billing portal 336. The communication module 326 coordinates communications between these external systems and internal components.

In various embodiments, the invoice processing system 300 may utilize crowdsourced website navigation patterns instead of AI for navigating biller websites. This approach may leverage collective user experiences to create and maintain navigation maps for various vendor portals, potentially reducing computational requirements and improving adaptability to website changes.

In some cases, and in one particular embodiment, the invoice processing system 300 may incorporate blockchain technology for invoice verification and storage. This implementation may enhance the security and immutability of invoice records, providing a tamper-proof audit trail for all processed invoices.

Further, in another embodiment, the invoice processing system 300 may implement tokenization and OAuth 2.0 protocols for credential-less bill retrieval. This approach may eliminate the need for storing sensitive user credentials, instead using temporary access tokens to securely retrieve invoice data from vendor systems.

In various implementations, the intelligent invoice presentment and ingestion system may be applied to streamline complex billing processes for organizations dealing with multiple vendors, service providers, and internal departments across different geographical locations. For example, a company operating in several countries and managing hundreds of vendors may utilize the system to efficiently handle diverse invoice formats and billing systems.

The invoice processing system 300 orchestrates a comprehensive workflow for retrieving and managing invoices from diverse sources. For example, by way of example, when a new invoice arrives, it is received by the message inbox 302, triggering a series of coordinated actions across the system. The partner biller manager 304 identifies the invoice source and works with the network interface 306 and account system 308 to establish secure connections and retrieve relevant configuration data. For partner billers, the partner integration module 310 processes the invoice using predefined rules. Simultaneously, the biller interface 312 and biller api manager 314 handle invoices from API-supported billers, utilizing the vendor database 316 for authentication and endpoint information. For web-based portals without direct integration, the browser module 318 simulates user interactions, sometimes requiring access to the customer email inbox 320 for authentication purposes. The retrieval subsystem 324 oversees this multi-faceted process, with its communication module 326 coordinating between components. For password-protected portals, the credential manager 328 works in tandem with the AI navigation engine 330 to securely access and navigate vendor billing portals. Throughout the process, the system may interact with external systems like the customer message system 334 for user notifications or authentication requests. As invoices are collected from various sources, they are normalized and consolidated in the message inbox 302, ready for further processing or integration with other financial systems. This intricate yet streamlined process ensures efficient and secure invoice retrieval and management across multiple platforms and integration methods.

This intelligent invoice presentment and ingestion system represents a significant advancement over prior art systems in several key aspects. Traditional invoice management solutions typically rely on static, predefined integration methods that struggle to adapt to the diverse and ever-changing landscape of billing platforms. These conventional systems often require manual intervention to handle changes in vendor portals or API structures, leading to frequent disruptions in data retrieval and increased maintenance overhead. In contrast, the present system employs an AI-driven navigation module that can dynamically adapt to changes in website layouts and portal structures in real-time. This adaptive capability ensures consistent bill extraction even when billing portals undergo updates or modifications, significantly reducing the need for manual reconfiguration and improving overall system reliability.

Furthermore, prior art systems generally lack the sophisticated credential management and multi-factor authentication handling capabilities present in this new approach. Conventional solutions often store user credentials in less secure formats or struggle to manage the complex authentication processes required by modern financial platforms. The present system, however, incorporates a secure credential management module that utilizes advanced encryption techniques for storing and managing user credentials. It also features a user communication hub capable of automatically handling multi-factor authentication requests, streamlining the data retrieval process across various secure platforms. This comprehensive approach to security and authentication, combined with the system's ability to aggregate data from diverse sources including direct biller relationships, open APIs, and password-protected websites, provides a level of integration and efficiency that surpasses traditional invoice management solutions.

As such, the disclosure herein which includes an AI-driven adaptive navigation capability, allows the system to dynamically adjust to changes in website layouts and API structures in real-time without manual intervention. This is in contrast to traditional systems that rely on static, predefined integration methods requiring frequent manual updates. This adaptive AI navigation, combined with advanced secure credential management and the ability to handle complex authentication processes across diverse platforms, enables the system to maintain consistent and reliable data retrieval from a wide range of sources. It significantly reduces the need for manual reconfiguration and maintenance, overcoming major limitations of existing invoice management technologies.

In various embodiments, the AI-driven navigation system adapts to changes in website layouts or API structures through a continuous learning mechanism enhanced by a layout comparison approach. The system retains a copy of the last successful layout or API schema and uses a multi-modal model to analyze the current version, generating a “diff” that highlights structural or content-level changes. This diff includes visual discrepancies, DOM changes, or API response variations. Once the diff is created, the system queries a large language model (LLM) with the context of the detected changes and the original navigation logic. The LLM interprets the differences and suggests how the navigation process should adjust-such as updating element selectors, changing input field mapping, or modifying the sequence of actions. This process allows the AI-driven navigation system to adapt dynamically, ensuring reliable interaction with the updated interface without requiring manual reprogramming.

In various embodiments, the system employs specific AI technologies and algorithms for error detection and resolution during data retrieval processes. Error detection leverages techniques including supervised learning for anomaly classification and natural language processing (NLP) to interpret error messages from APIs or web interactions. For error resolution, the system employs a multi-modal large language model (LLM) that uses a multi-shot technique to enhance its effectiveness. When an error occurs, the system compiles a context input for the LLM that includes the current error details along with examples of similar past errors and their resolutions. These historical cases provide additional context, enabling the LLM to draw on precedent when diagnosing and addressing the issue. This approach allows the LLM to suggest or execute corrective actions more accurately, such as retrying with adjusted parameters, re-authenticating sessions, or modifying query formats. If automated resolution is not feasible, the system escalates the issue with detailed logs for manual intervention. The resolution by manual intervention gets stored in a database of the resolutions for future cases.

In various embodiments, the system adopts a hybrid strategy to handle multi-factor authentication (MFA) when accessing password-protected portals. For one-time MFA challenges, the system detects the authentication request and immediately notifies the user, prompting them to input the code received on their device. For recurring access scenarios, the system integrates with the inbox or message service associated with the account to fetch MFA codes. It automatically applies the code, completing the authentication without user intervention.

In various embodiments, the system employs a priority-based scheduling mechanism to manage the retrieval of invoices from multiple sources simultaneously, with a focus on retrieving the most recent invoices first. The system categorizes sources by factors such as bill freshness, user preferences, and billing cycles. Tasks are dynamically queued, with higher priority given to sources likely to provide the latest data. Multi-threaded processing enables simultaneous retrieval from multiple sources, ensuring timely aggregation while isolating and addressing errors without disrupting other tasks.

In various embodiments, the system uses a multi-layered failsafe approach to address unexpected website structures. The Incremental Method cycles through a series of alternative navigation strategies, leveraging its built-in adaptability to identify key elements using different interaction techniques. When standard methods fail, an Enhanced Model is invoked, which is a larger, more computationally powerful AI model that analyzes the website's layout and suggests precise navigation steps. If both automated approaches are unsuccessful, the system flags the issue, logs comprehensive context data, and escalates it for manual intervention as a Fallback to Manual option.

In various embodiments, the system handles potential conflicts or discrepancies in billing data from different sources by aggregating and presenting all bills to the user, marking inconsistencies for easy identification. If fraudulent or anomalous activity is detected (such as charges that deviate significantly from historical patterns) the system proactively notifies the user and suggests appropriate actions, such as confirming with the biller, disputing the charge, or flagging it for further review.

In various embodiments, the user interface may display key information such as Invoice number, Uploads, Notes, Vendor, PO number, Chart of account, Bill type, Created date, Invoice date, Due date, Currency, Invoice amount, Balance due, Type, Payment status, and/or Approval status. Users can interact with bills through simple actions like viewing, downloading, or marking as paid. A notification panel alerts users to upcoming due dates or flagged issues, such as anomalies or conflicting data. Settings and account management features are accessible via a dedicated menu.

In various embodiments, the system ensures the authenticity and integrity of retrieved invoice data through source-specific measures. For Trusted Sources with established contracts and authenticated APIs, the system relies on techniques like SSL encryption and API token verification. For Unverified Sources where contracts or authentication are not available, the system uses heuristic analysis to cross-check invoice details against historical records, patterns, or user-provided inputs.

In various embodiments, it is to be appreciated that while the term “invoice” has been used throughout this description, it is to be appreciated that the systems and methods described herein may be applicable to a wide range of financial documents. The intelligent document presentment and ingestion system may be capable of retrieving, processing, and managing various types of financial records, including but not limited to receipts, purchase orders, statements, credit notes, financial documents, and/or expense reports. This versatility allows the system to provide a comprehensive solution for financial document management across diverse business needs and scenarios.

In various embodiments, the generality of the technology described in this application extends beyond invoices and financial documents. The adaptive AI-driven navigation, secure credential management, and intelligent data retrieval and processing techniques may be applied to accessing and managing a broad spectrum of documents and resources. This may include, but is not limited to, legal documents, medical records, academic transcripts, or any other type of information that requires secure access, normalization, and consolidation from multiple sources. The core principles of the system -adaptive navigation, secure access, and intelligent processing-may be applicable across various domains and industries.

Further, it is important to note that the approach described throughout this patent application is not tied exclusively to invoices or financial documents. The underlying technology, including the AI navigation engine, the credential management system, and the data normalization processes, may be adapted to retrieve and process any kind of document or resource from diverse sources. This generality of the technology allows for potential applications in numerous fields where secure, automated access to varied information sources is required. As such, the systems and methods detailed herein may represent a versatile framework for intelligent information retrieval and management across multiple domains.

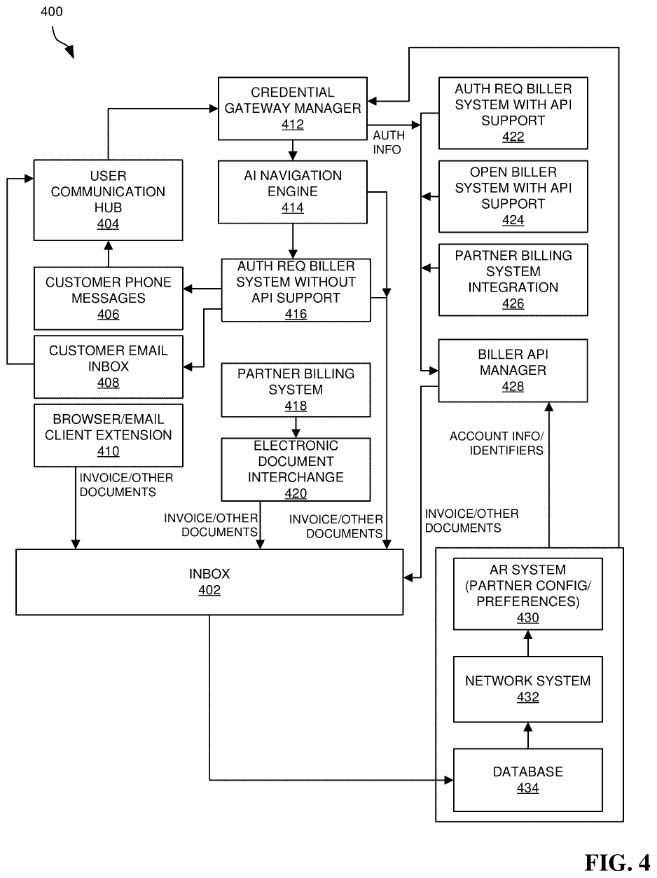

FIG. 4 illustrates a block diagram of a document processing system 400, in accordance with one embodiment. As an option, the document processing system 400 may be implemented in the context of any one or more of the embodiments set forth in any previous and/or subsequent Figures and/or description thereof. Of course, however, the document processing system 400 may be implemented in the context of any desired environment. Further, the aforementioned definitions may equally apply to the description below.

The document processing system 400 includes a message inbox 402 that receives and consolidates documents from multiple sources. A communication hub 404 manages user interactions and connects to a phone message module 406 and an email inbox module 408. A client extension module 410 interfaces with the system to handle invoice and other document processing.

In some cases, the message inbox 402 may serve as a centralized repository for all incoming documents, including invoices, bills, and related financial communications. The communication hub 404 may facilitate seamless interaction between users and the system, handling various communication channels to ensure efficient document retrieval and processing.

The document processing system 400 includes a credential manager 412 that interfaces with a navigation engine 414. The navigation engine 414 connects to an authentication system 416 for handling systems without API support. A partner system 418 connects to a document exchange module 420 for processing electronic documents.

The credential manager 412 may employ advanced encryption techniques to securely store and manage user credentials for accessing password-protected sources. The navigation engine 414 may utilize artificial intelligence to adaptively navigate and extract bills from password-protected portals, ensuring consistent document retrieval even when website layouts change.

The system incorporates multiple biller interfaces, including an authentication biller module 422 and an open biller module 424 for systems with API support. An integration module 426 handles partner billing system connections. An api manager 428 processes account information and identifiers from these various sources.

In some cases, the authentication biller module 422 may handle interactions with billing systems that require user authentication, while the open biller module 424 may manage connections with systems offering open APIs. The integration module 426 may ensure seamless data exchange between the document processing system 400 and various partner billing systems.

A configuration system 430 manages partner configurations and preferences. The configuration system 430 connects to a network module 432, which in turn connects to a storage module 434 for maintaining system data.

The configuration system 430 may allow for customization of document retrieval and processing parameters based on specific partner requirements or user preferences. The network module 432 may facilitate secure communication between various system components and external sources, while the storage module 434 may provide robust data management capabilities for long-term document storage and retrieval.

The document processing system 400 may employ a continuous learning mechanism enhanced by a layout comparison approach to adapt to changes in website layouts or API structures. This mechanism may involve retaining a copy of the last successful layout or API schema and using a multi-modal model to analyze the current version, generating a “diff” that highlights structural or content-level changes.

In various embodiments, the document processing system 400 may use a multi-shot technique with the multi-modal large language model to enhance error detection and resolution effectiveness. When an error occurs, the system may compile a context input for the large language model that includes the current error details along with examples of similar past errors and their resolutions, enabling more accurate diagnosis and resolution of issues.

In various embodiments, the document processing system 400 may use a multi-layered failsafe approach to address unexpected website structures. This approach may include an incremental method that cycles through alternative navigation strategies, an enhanced model that invokes a more powerful AI model for precise navigation suggestions, and a fallback to manual intervention when automated approaches are unsuccessful.

In various embodiments, the document processing system 400 may adopt a hybrid strategy to manage multi-factor authentication challenges. For one-time challenges, the system may immediately notify the user and prompt for input. For recurring access scenarios, the system may integrate with the user's message services to automatically fetch and apply authentication codes, streamlining the document retrieval process.

In various embodiments, the credential manager 412 may serve as a subsystem for securely storing and managing credentials for third-party biller systems that require authentication or authorization. This component may employ various methods such as API keys and username/password combinations to help ensure secure access to these external systems. The credential manager 412 may play a role in maintaining the integrity and confidentiality of user credentials, potentially facilitating seamless and secure interactions with password-protected billing portals.

In various embodiments, the api manager 428 may act as a component for integrating and securely fetching invoices, payment schedules, purchase orders, receipts, and other related data via API protocols. This module may be designed with AI-driven error handling capabilities to help ensure robust data retrieval, even in the face of API updates or outages. The api manager 428 may be capable of interfacing with three distinct types of billers: those with direct partnerships providing proprietary APIs, billers with open APIs requiring basic information, and billers with public APIs requiring authentication. For each type, the manager may employ specific strategies to fetch and process the required data, potentially storing the retrieved documents in the message inbox 402.

In various embodiments, the document exchange module 420 may facilitate the structured exchange of electronic business documents between BILL and its partners. By potentially adhering to standardized formats, this module may enable seamless and automated communication for documents such as invoices, purchase orders, and receipts. This process may enhance efficiency and data accuracy, potentially benefiting partners through faster invoice processing, improved cash flow, and strengthened relationships with their customers. The document exchange module 420 may play a role in reducing manual data entry and potentially minimizing the risk of errors in document exchange.

In various embodiments, the communication hub 404 may manage interactions on behalf of the customer, handling various aspects of user communication and authentication. This component may be responsible for managing verifications and messages required for multi-factor authentication, such as email or SMS confirmations. Additionally, it may interface with the customer to provide notifications, summaries, and status updates, potentially ensuring that users are kept informed about their billing activities and any important system events or alerts.

In various embodiments, the navigation engine 414 may serve as the core AI module, potentially utilizing a multi-modal large language model capable of processing image, text, and computer-readable markup to handle complex website navigation. This AI agent may simulate human-like interactions by processing visual inputs of website layouts in real-time, potentially understanding elements such as buttons and text fields through advanced computer vision and natural language processing techniques. The navigation engine 414 may generate precise keyboard and mouse actions to log in, navigate menus, and extract billing information, potentially adapting dynamically to UI changes and mimicking user behavior. This capability may help ensure robust performance and seamless access to billing data, even on websites that lack standardized structures or experience frequent updates.

In various embodiments, the disclosed adaptive invoice aggregation and management system may significantly improve upon prior art systems by employing advanced artificial intelligence techniques for navigating and extracting billing information from diverse sources. Unlike traditional systems that often rely on static scraping methods or rigid API integrations, this system may utilize a multi-modal large language model capable of adapting to changes in website layouts, API structures, and authentication processes in real-time. This adaptive approach may allow the system to maintain consistent access to billing data even when source websites undergo updates or modifications, potentially reducing the need for frequent manual reconfiguration and minimizing disruptions in data retrieval.

In various embodiments, the system may also enhance security and user convenience through its innovative handling of multi-factor authentication and credential management. While prior art systems may struggle with evolving security measures implemented by billing portals, this system may employ a hybrid strategy that can handle both one-time and recurring multi-factor authentication challenges. By integrating with users' message services to automatically fetch and apply authentication codes, the system may streamline the data retrieval process without compromising security. Furthermore, the system's ability to consolidate and normalize billing data from heterogeneous sources into a unified format, coupled with its AI-powered error detection and resolution capabilities, may provide users with a more comprehensive and reliable view of their financial obligations than traditional invoice management solutions.

### Use-Case Scenario: Fetching Documents From Partners

In various embodiments, the system may automatically fetch documents from partners, such as a large retail chain generating thousands of invoices daily. The system may connect to the partner's dedicated API, authenticate using secure credentials, and retrieve the latest batch of invoices. These documents may then be processed and stored in the inbox, ready for the retail chain's customers to access and pay through the platform.

### Use-Case Scenario: Providing a Mechanism for Partners to Send their Documents to Inbox

In various embodiments, the system may provide a mechanism for partners to send their documents to the inbox. For example, a software-as-a-service company may integrate with the document exchange module to automatically send their subscription invoices. The company's billing system may use a secure API endpoint to push invoices as they are generated. These documents may be received, validated, and stored in the inbox system, streamlining the invoicing process for the SaaS company and its customers.

### Use-Case Scenario: Fetching Documents From Billers With APIs That Only Require Basic Account Information

In various embodiments, the system may fetch documents from billers with APIs that only require basic account information, such as utilities or RPPS providers. For instance, a small business owner may use the platform disclosed herein to manage their utility bills. The system may securely store the business's account numbers for various utilities. On a monthly basis, the biller api manager may automatically connect to these utility providers' APIs, using only the stored account numbers to authenticate and retrieve the latest statements. These bills may then be presented to the business owner in their inbox for review and payment.

### Use-Case Scenario: Fetching Documents From Billers APIs That Require Authentication/Authorization

In various embodiments, the system may fetch documents from biller APIs that require authentication or authorization. For example, a freelance professional may use the system to manage their cloud service subscriptions. The system may securely store the user's login credentials for various cloud providers. The AI navigation engine may periodically log into these services using the stored credentials, navigate to the billing section, and download the latest invoices. These documents may then be processed and added to the user's inbox, providing a centralized view of their cloud service expenses.

### Use-Case Scenario: Fetching or Routing Documents From Billers Without API Support

In various embodiments, the system may fetch or route documents from billers without API support. For instance, a small manufacturing company may receive invoices from a supplier that doesn't offer API access. The AI navigation engine may simulate user behavior to log into the supplier's web portal using stored credentials. It may navigate through the portal, locate the latest invoices, and extract the relevant information. Alternatively, the system may configure the account to forward invoices to a designated email address. In either case, the invoices may be processed and added to the manufacturing company's inbox, integrating this manual-process vendor into the company's automated bill management workflow.

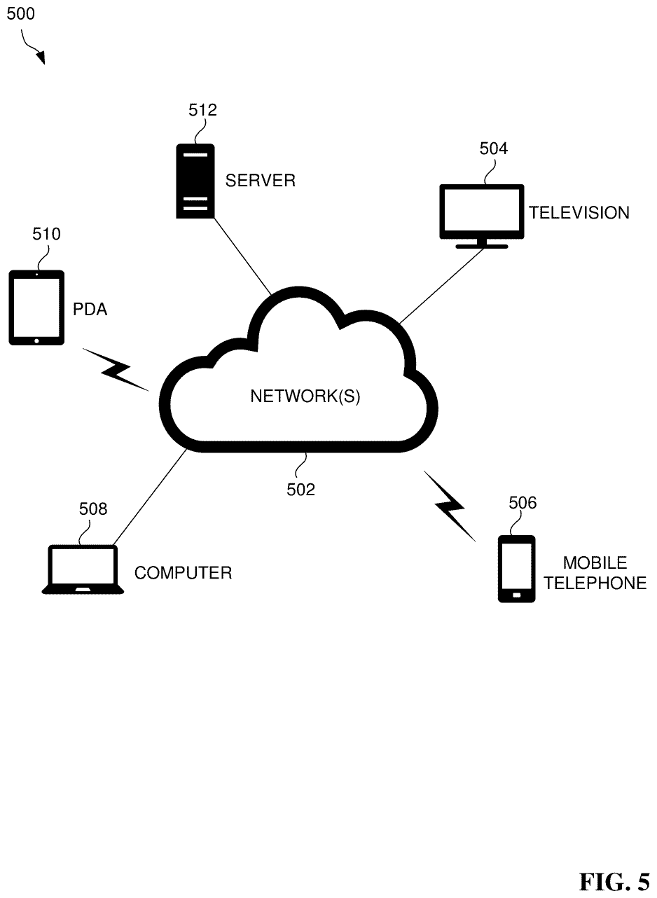

FIG. 5 illustrates a network system 500 for facilitating communication between multiple devices, in accordance with one embodiment. As an option, the network system 500 may be implemented in the context of any one or more of the embodiments set forth in any previous and/or subsequent Figures and/or description thereof. Of course, however, the network system 500 may be implemented in the context of any desired environment. Further, the aforementioned definitions may equally apply to the description below.

The network system 500 includes a cloud network 502 that serves as a central connection point for various devices. A display device 504 connects to the cloud network 502, enabling visual output capabilities. A mobile device 506 maintains wireless connectivity to the cloud network 502. A client computer 508 links to the cloud network 502, providing computing capabilities. A tablet device 510 connects wirelessly to the cloud network 502. A network server 512 interfaces with the cloud network 502, enabling data processing and storage functionality.

In some cases, the cloud network 502 may employ a distributed architecture, allowing for scalable and flexible resource allocation. The cloud network 502 may utilize virtualization technologies to create and manage virtual machines, containers, and other cloud resources dynamically based on demand.

The display device 504 may include various types of visual output devices, such as monitors, televisions, or digital signage. In some cases, the display device 504 may incorporate touch-screen capabilities, enabling user interaction directly through the display interface.

The mobile device 506 may encompass smartphones, tablets, or other portable computing devices. In some cases, the mobile device 506 may utilize cellular networks in addition to Wi-Fi connectivity to maintain a constant connection to the cloud network 502, ensuring seamless access to cloud-based services and data.

The client computer 508 may represent desktop computers, laptops, or workstations. In some cases, the client computer 508 may serve as a primary interface for users to access and manage their billing data and financial information stored in the cloud network 502.

The tablet device 510 may offer a balance between portability and functionality, providing a larger screen than typical mobile devices while maintaining ease of mobility. In some cases, the tablet device 510 may be equipped with stylus input capabilities, enabling more precise interactions with financial data and visualizations.

The network server 512 may handle various backend processes, including data storage, processing, and management. In some cases, the network server 512 may host databases containing user account information, billing records, and other sensitive data, implementing robust security measures to protect this information.

The network system 500 allows for data exchange and communication between all connected devices through the cloud network 502. This interconnected architecture enables seamless synchronization of billing data across multiple devices, ensuring users have access to up-to-date financial information regardless of the device they are using.

In various embodiments, the network system 500 may employ a hybrid cloud-edge computing architecture. This approach may involve performing sensitive operations, such as initial data processing and encryption, on edge devices like the mobile device 506 or client computer 508. Meanwhile, more resource-intensive tasks such as data aggregation, analysis, and long-term storage may be conducted in the cloud network 502.

In various embodiments, the network system 500 may incorporate advanced security protocols to protect data transmission between devices and the cloud network 502. This may include implementing end-to-end encryption, multi-factor authentication, and secure tunneling protocols to safeguard sensitive financial information as it traverses the network.

In various embodiments, the network system 500 may leverage artificial intelligence and machine learning algorithms to optimize network performance and resource allocation. These intelligent systems may analyze usage patterns, predict peak demand periods, and dynamically adjust network configurations to ensure efficient and responsive communication between devices and the cloud network 502.

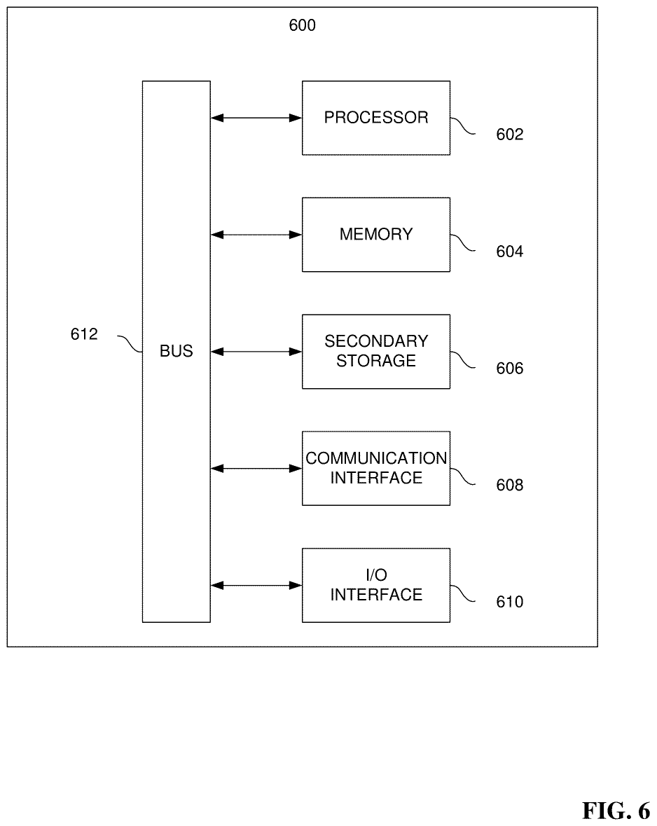

FIG. 6 illustrates a block diagram of a computing system 600, in accordance with one embodiment. As an option, the computing system 600 may be implemented in the context of any one or more of the embodiments set forth in any previous and/or subsequent Figures and/or description thereof. Of course, however, the computing system 600 may be implemented in the context of any desired environment. Further, the aforementioned definitions may equally apply to the description below.

The computing system 600 includes a processor 602, memory 604, secondary storage 606, communication interface 608, and input/output interface 610, all interconnected via a system bus 612. The processor 602 connects to the system bus 612 for executing instructions and processing data. The memory 604 couples to the system bus 612 and provides storage for program instructions and data.

In some cases, the processor 602 may be a multi-core processor capable of parallel processing, enhancing the overall performance of the computing system 600. The memory 604 may include various types of computer-readable media, such as random access memory (RAM) for fast data access and cache memory for temporary storage of frequently accessed data.

The secondary storage 606 connects to the system bus 612 to provide additional data storage capacity. The secondary storage 606 may include non-volatile memory devices, such as solid-state drives or hard disk drives, for long-term data storage.

In some cases, the secondary storage 606 may also include removable storage media, such as optical discs or flash drives, allowing for easy data transfer between different computing systems. The secondary storage 606 may store large datasets, system backups, or infrequently accessed files, complementing the faster but more limited memory 604.

The communication interface 608 links to the system bus 612 to enable data exchange with external devices and networks. The communication interface 608 may include wired connections, such as Ethernet ports, as well as wireless interfaces like Wi-Fi or Bluetooth modules.

In some cases, the communication interface 608 may support multiple network protocols, allowing the computing system 600 to interact with various external systems and services. This versatility enables the computing system 600 to participate in distributed computing environments, cloud-based services, or Internet of Things (IoT) ecosystems.

The input/output interface 610 connects to the system bus 612 to facilitate interaction with external input and output devices. The input/output interface 610 may support a wide range of peripherals, including keyboards, mice, displays, printers, and specialized input devices.

In some cases, the input/output interface 610 may include support for advanced interaction technologies, such as touchscreens, voice recognition systems, or gesture-based controls. This flexibility allows the computing system 600 to adapt to various user interaction preferences and accessibility requirements.

The system bus 612 serves as the main communication pathway between all components, enabling data and control signal transmission throughout the computing system 600. The system bus 612 may employ various architectures and protocols to ensure efficient data transfer between components with different speed and bandwidth requirements.

In some cases, the system bus 612 may incorporate multiple bus types, such as a high-speed bus for time-sensitive data transfers and a separate bus for lower-priority communications. This hierarchical structure helps optimize overall system performance by balancing data throughput with component-specific needs.

The computing system 600 may achieve scalability through a combination of distributed computing and modular design. By leveraging cloud computing resources, the system may dynamically allocate processing power and storage capacity based on current demands, ensuring efficient resource utilization.

In various embodiments, the computing system 600 may incorporate specialized hardware accelerators, such as graphics processing units (GPUs) or tensor processing units (TPUs), to enhance performance for specific tasks like machine learning or data analytics. These accelerators may connect directly to the system bus 612 or interface through the processor 602, depending on the system architecture.

In various embodiments, the computing system 600 may implement virtualization technologies, allowing multiple virtual machines or containers to run on the same physical hardware. This approach may enhance resource utilization, improve system isolation, and facilitate easier deployment and management of complex software environments.

In various embodiments, the computing system 600 may incorporate advanced power management features, dynamically adjusting component performance and power consumption based on workload and energy efficiency requirements. This may include techniques such as dynamic voltage and frequency scaling for the processor 602 or selective power-down of unused components to extend battery life in mobile configurations.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A system for intelligent invoice presentment and ingestion, comprising:
a processor; and
a memory storing instructions that, when executed by the processor, cause the system to:
retrieve billing data from multiple sources including direct biller relationships, emails, email attachments, open APIs, secured APIs, open websites or portals, and password-protected websites or portals;
securely store and manage user credentials for accessing password-protected sources;
utilize artificial intelligence (AI) to adaptively navigate and extract bills from at least one of open websites, open portals, or password-protected portals, or configure email forwarding to receive bills in a designated customer billing inbox;
perform automated synchronization for recurring data retrieval tasks;
normalize billing data from various sources into a unified format; and
present the consolidated billing data to a user through a user interface.

2. The system of claim 1, wherein the AI utilizes a multi-modal large language model to process visual inputs, text, and computer-readable markup for navigating password-protected portals.

3. The system of claim 2, wherein the AI employs computer vision and natural language processing techniques to interpret website screen layouts in real-time.

4. The system of claim 1, wherein the system further comprises a user communication hub for managing interactions on behalf of the user, including handling verifications and messages needed for multi-factor authentication.

5. The system of claim 4, wherein the user communication hub interfaces with the AI to automatically process authentication requests and provide necessary responses.

6. The system of claim 1, wherein:
the secure storage of user credentials utilizes advanced encryption techniques; and
the system employs multi-factor authentication for accessing the stored credentials.

7. The system of claim 1, wherein the automated synchronization includes:
scheduling and executing periodic data retrieval tasks based on predefined intervals; and
implementing error handling and retry mechanisms to address temporary connectivity issues.

8. The system of claim 1, wherein the normalization of billing data includes:
standardizing date formats, currency representations, and invoice structures across different billing sources; and
appending additional contextual information or metadata to the billing data.

9. The system of claim 1, wherein presenting the consolidated billing data includes:
generating interactive visualizations and summary reports; and
providing customizable views and filtering options to cater to different user preferences.

10. The system of claim 9, wherein the system further incorporates AI-powered insights and recommendations based on the consolidated billing data.

11. The system of claim 1, wherein the system further comprises a machine learning-based anomaly detection module that identifies unusual patterns in billing data.

12. The system of claim 11, wherein the anomaly detection module alerts users to potential errors or fraudulent charges.

13. The system of claim 1, wherein the AI navigation module is further enhanced with natural language generation capabilities to interact with customer service chatbots on biller websites.

14. The system of claim 1, wherein the system integrates with external financial planning tools, allowing users to incorporate their consolidated billing data into broader financial analyses and forecasts.

15. The system of claim 1, wherein:
the system utilizes crowdsourced website navigation patterns for navigating biller websites; and
the crowdsourced patterns are aggregated from anonymized user experiences.

16. The system of claim 1, wherein the system incorporates blockchain technology for invoice verification and storage, providing a tamper-proof audit trail for all processed invoices.

17. The system of claim 1, wherein the system implements tokenization and OAuth 2.0 protocols for credential-less bill retrieval, eliminating the need for storing sensitive user credentials.

18. The system of claim 1, wherein the system employs a hybrid cloud-edge computing architecture, performing sensitive operations on edge devices and conducting data aggregation and analysis tasks in the cloud.

19. A method, comprising:
at a computer system:
retrieving billing data from multiple sources including direct biller relationships, emails, email attachments, open APIs, secured APIs, open websites or portals, and password-protected websites or portals;
securely storing and managing user credentials for accessing password-protected sources;
utilizing artificial intelligence (AI) to adaptively navigate and extract bills from at least one of open websites, open portals, or password-protected portals, or configure email forwarding to receive bills in a designated customer billing inbox;
performing automated synchronization for recurring data retrieval tasks;
normalizing billing data from various sources into a unified format; and
presenting the consolidated billing data to a user through a user interface.

20. A non-transitory computer-readable media storing computer instructions which when executed by one or more processors of a device cause the device to:
retrieve billing data from multiple sources including direct biller relationships, emails, email attachments, open APIs, secured APIs, open websites or portals, and password-protected websites or portals;
securely store and manage user credentials for accessing password-protected sources;
utilize artificial intelligence (AI) to adaptively navigate and extract bills from at least one of open websites, open portals, or password-protected portals, or configure email forwarding to receive bills in a designated customer billing inbox;
perform automated synchronization for recurring data retrieval tasks;
normalize billing data from various sources into a unified format; and
present the consolidated billing data to a user through a user interface.
